(19) United States
(12) Patent Application Publication
(10) Pub. No.: US 2004/0176915 A1
(43) Pub. Date: Sep. 9, 2004

(54) Apparatus and method for encoding chemical structure information

(76) Inventors: Antony Williams, Wake Forest, NC (US); Ian Dugdale, Kingwood, TX (US); Valery Tkachenko, Moscow (RU)

Correspondence Address: TESTA, HURWITZ & THIBEAULT, LLP, HIGH STREET TOWER, 125 HIGH STREET, BOSTON, MA, 02110, US

(21) Appl. No.: 10/382,461

(22) Filed: Mar. 6, 2003

(51) Int. Cl. G06F 19/00; G01N 31/00; G06F 7/00; G06F 17/00

(52) U.S. Cl. 702/22; 707/102

(57) ABSTRACT

A method of encoding chemical information into a symbol, like a bar code, is provided such that the generated symbol represents the chemical structure information. A processor can be used to generate a string that describes chemical structure information. The string can then be sent to a homogenizer, which creates a standardized data format. The standardized data format can then be passed to a symbol generating function, which creates a symbol that encodes the chemical structural information. A scanner can then be used to decode the symbol, revealing the chemical structural information.

### FIELD OF THE INVENTION

The present invention relates generally to the field of information processing. In particular, the invention relates to chemical structure encoding apparatuses and methodologies.

### BACKGROUND OF THE INVENTION

Cataloging and differentiating large volumes of complex data is a demanding component of modern day industrial and corporate activity. In the chemical and pharmaceutical industries, this problem is particularly acute, since there is a need to store complex information concerning the structure of compounds and substances. Moreover, in these industries, professionals rely upon chemical structure information to provide them with molecular information essential to experimentation and data management efforts alike. Therefore it is important that this information be readily available in a quickly procurable form.

Displaying the structure of a substance is often a challenge, given the surface area constraints and the operational limitations of various media recording techniques. To overcome these issues as well to address the general problem of chemical data management, chemical indices that point to an entry in a database are often used. Thus, the traditional process of linking a database entry to a real world object can be used to inventory chemical compounds. This approach is helpful in various circumstances, yet not without limitations. Developing and maintaining databases is time consuming. Furthermore, simple data indexing, such as associating a number with an object, is of limited value for various scientific applications. Thus, there remains a need to store chemical structure information in a format that eliminates the use of databases, while still providing users with detailed information that is readily available.

### SUMMARY OF THE INVENTION

In one aspect, the present invention relates to providing a method of encoding chemical information which includes the steps of providing chemical structure information and generating a symbol having a specific configuration in response to the chemical structure information such that the chemical structure information is derivable from the specific configuration of the symbol. In one embodiment, the symbol is a two dimensional barcode. In another embodiment, the symbol is scanned to obtain the chemical structure information. In a further embodiment, the method comprises the step of generating a character string from the chemical structure information. In various embodiments, suitable symbols include but are not limited to barcodes, glyphs, codes, data strings, and other suitable data encoding symbols presently available or as of yet undeveloped.

In another aspect, the invention relates to providing a method of encoding chemical structure. The method includes the steps of providing chemical structure information, generating a character string from the information, and converting the character string into homogenized chemical structure data. After homogenized chemical structure data has been created, a symbol is generated in response to the data, such that the symbol is functionally related to the chemical structure information. In another embodiment, the chemical structure information includes at least atomic position information and atomic connectivity information.

In another aspect, the invention provides an apparatus for processing chemical structure information. The apparatus includes a processor for receiving and processing chemical structure information such that the processor generates a symbol that is functionally related to the chemical structure information. Also included in the apparatus is an output device that is electronically connected to the processor for displaying the symbol. In another embodiment, the processor is a computer or a personal digital assistant. In yet another embodiment, the output device is a printer, or a display.

In another aspect, the invention provides an apparatus for processing a symbol encoding chemical structure information which includes a processor for receiving and processing symbol scan information. The processor, in response to the symbol scan information, generates chemical structure information that is functionally related to the symbol. Also included in the apparatus is a scanning device that is electronically connected to the processor. The scanning device scans the symbol and transmits the symbol scan information to the processor. In another embodiment, the scanning device is a handheld laser scanner.

In another aspect of the invention, the invention relates to a system for encoding and decoding chemical structure information. The system includes a processor for encoding chemical information as a symbol and decoding the chemical information contained within the symbol. In this system, the chemical structure information and the symbol are derivable from each other. Included in the system is a symbol scanner electronically connected to a processor for transmitting symbol scan information to the processor. The processor then converts the provided symbol scan information into chemical structure information. The system also includes an output device electronically connected to the processor for displaying the symbol created in response to the chemical structure information.

In another aspect, the invention relates to a symbol for encoding chemical structure information. The symbol includes a plurality of geometric regions disposed within a defined area, and also includes a second plurality of geometric regions chromatically distinct from the first plurality of regions and disposed within the same defined area. In this aspect of the invention, the arrangement of the chromatically distinct regions encodes a chemical structure of interest.

In yet another aspect of the invention, the invention relates to a method of encoding chemical structure information. The method includes providing a first plurality of geometric regions disposed within a defined area and also a second plurality of geometric regions chromatically distinct from the first plurality of regions and disposed within the same defined area. In this method, the first and second chromatically distinct regions encode a chemical structure of interest.

### BRIEF DESCRIPTION OF THE DRAWINGS

The foregoing and other objects, aspects, and advantages of the invention and the various features thereof may be more fully understood from the following description when read together with the accompanying drawings. In the drawings, like reference characters generally refer to the same parts throughout the different views.

FIG. 1-A depicts the chemical structure of Taxol, a molecule which is suitable for processing by various aspects of the invention.

FIG. 1-B depicts the SMILES string for Taxol, a representative chemical structure format that can be used to describe chemical structure information.

FIG. 1-C is a representative 2-D symbol that can be used to encode chemical structure information as described in various embodiments of the invention.

FIG. 2 and FIG. 2A depict an embodiment of the process of converting chemical structure information into a symbol.

FIG. 3 and FIG. 3A depict an embodiment of the process of converting chemical structure information into a symbol with a homogenizing step included.

FIG. 4 depicts an embodiment of a SKP format, which can be used as a homogenizing data format in accordance with some aspects of the invention.

FIGS. 5A-M represent different forms of symbols that are suitable for encoding chemical structure information in accordance with some embodiments of the invention.

### DETAILED DESCRIPTION OF THE INVENTION

Embodiments of the present invention are described below. It is, however, expressly noted that the present invention is not limited to these embodiments, but rather the intention is that modifications that are apparent to the person skilled in the art and equivalents thereof are also included.

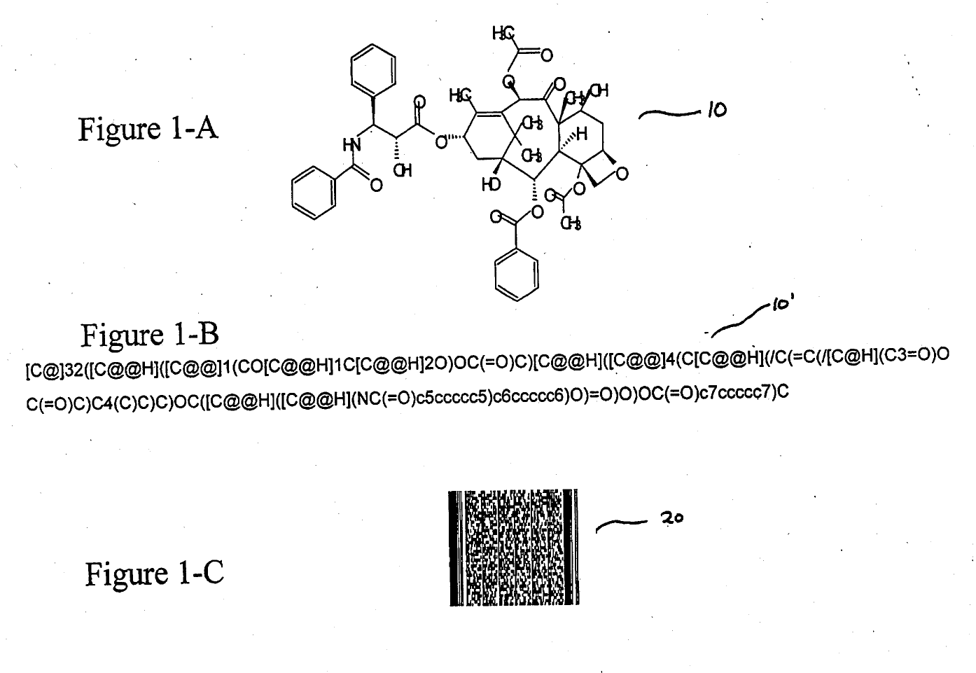

Turning to FIG. 1-A, the chemical structure of Taxol 10 is shown. As can be observed from the figure, the structure is complicated when represented in the present form. It will be appreciated that printing the structure of Taxol upon a small label for inclusion on a reagent vial, as may occur in the chemical and pharmaceutical industries, is likely to be precluded by surface area constraints. Moreover, if a label bearing the structural representation is too small, a professional examining the label may miss important chemical information when interpreting the structure. The problems associated with displaying the chemical structure of Taxol on a small label become more acute when an attempt is made to display even larger more complex chemical structures.

Turning to FIG. 1-B, a textual representation of Taxol 10′ as a SMILES (Simplified Molecular Input Line Entry System) string is shown. SMILES is a machine readable line notation for representing chemical structure. The SMILES string for Taxol 10′ is long, complex, and difficult to interpret given its 169 constituent characters. Thus, it would be difficult to label a small vial with the SMILES representation of Taxol 10′ such that the text remains readable. Further, even if the text can be read, the text string length makes it difficult to interpret the chemical structure of the compound from the SMILES string.

Referring to FIG. 1-C, symbol based embodiments, such as the exemplary barcode symbol illustrated, overcome the difficulties encountered in displaying the chemical structure of a compound, or a textual representation of the chemical structure in a machine readable format. FIG. 1-C is a representative 2-D symbol 20 that is used to encode chemical structure information. The 2-D symbol 20 can store data along its length and height, through the use of chromatically distinct regions. The 2-D symbol 20 can be used to encode chemical structure information and other chemical information, such that the information encoded is functionally related to the chemical structure information, rather than being a pointer to a location in a database that holds the information. Currently, over twenty different 2-D symbologies are available to store information, as are described below. Preferred symbols have a large storage capacity, are resistant to damage, and have an error correction and detection capability. The number of potentially suitable symbologies is virtually without limit.

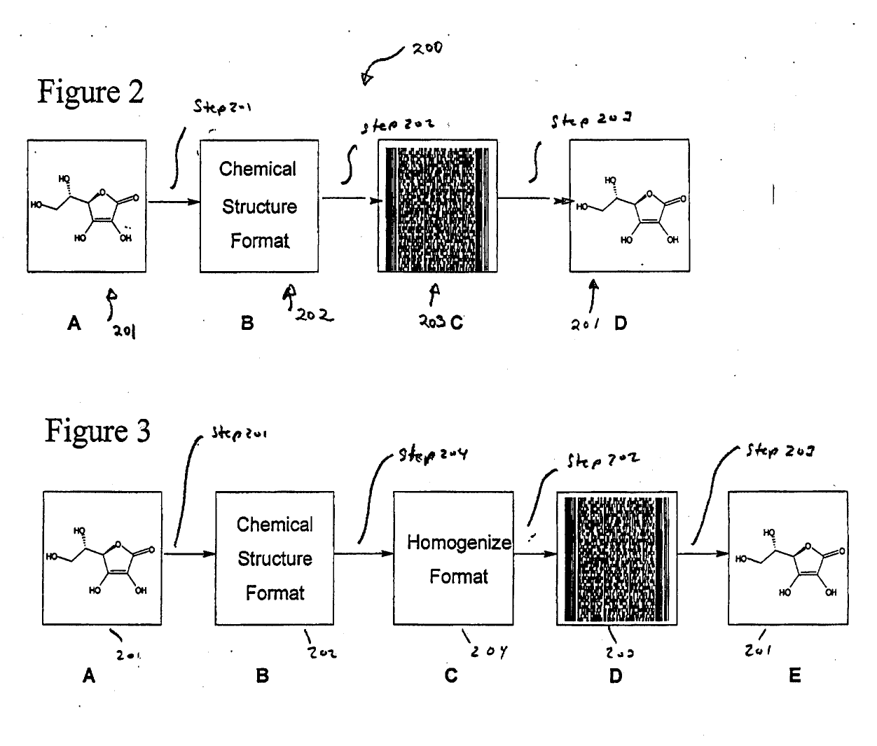

Turning to FIG. 2 and FIG. 2A, the process 200 of encoding chemical structure information within a symbol is displayed. As will be described, chemical structure information is encoded and decoded from a symbol without the use of an external database. More particularly, details concerning the atomic positioning of atoms and bonds, and the types of elements and bonds in the molecule, such as Taxol, are embedded directly into the symbol.

In the first part of the process 200, chemical structure information 201 is provided. The chemical structure, in either a 2-D or a 3-D format, is created using a chemical structure drawing package. A number of commercial packages are available for this purpose, including ChemDraw (CambridgeSoft Corporation, Cambridge, Mass., 02140, USA), ISIS/Draw (MDL Information Systems, Inc., San Leandro, Calif., 94577, USA), ChemWindow (Bio-Rad Informatics/Sadtler Group, Philadelphia, Pa., 19104-2596, USA) and ACD/ChemSketch (Advanced Chemistry Development, Inc., Toronto, Ontario, Canada, MVH 3V9). The drawing packages are executed by a processor, which could be contained in a personal computer, or a personal digital assistant (PDA). Processors suitable for executing aspects of the invention may be computers or electronic devices themselves, or constituent elements of other devices capable of executing method steps. These drawing packages may include the ability to scan images of molecular structures, which are then interpreted by the package to produce a connection table.

In the second stage of the process 200, chemical structure information is converted (Step 201) into a chemical structure format 202 using a software package. The software package is run by a processor, which can be part of a personal computer, a personal digital assistant, or other suitable instruction processing device. Depending on the software package used in the generation of the chemical structure information in the first part of the process 201, different chemical structure formats will result as output data. Representative formats include .molfile or .skc produced by ISIS/Draw, .cdx or .chm produced by ChemDraw, and .sk2 produced by ChemSketch. In addition to the above formats, other textual formats are available to describe chemical structure information. Suitable textual formats include but are not limited to SMILES, CML (Chemical Markup Language), ASCII representations, binary representations, low level programming language elements, and other formats not yet developed. The IUPAC Chemical Identifier, or IChI identifier is also a suitable textual format.

In the third stage of the process 200, the chemical structure format 202 is converted (Step 202) into a symbol 203 using a processor. Again, the processor could be a device in electrical communication with a personal computer, or a personal digital assistant. Additionally, a personal computer and a personal digital assistant can serve as processors in various embodiments. Generally, the chemical structure format is received as input by a standardized symbol generating package. An example of a symbol generating package is TbarCode ActiveX (TEC-IT, Datenverarbeitung GmbH, AT-4400 Steyr, Austria).

The converted symbol is then transferred to an output device, which is in electronic communication with the processor executing a symbol generating program. The output device can potentially be a monitor, a laser printer, a dot matrix printer, a thermal printer, an etching device, or any device suitable for rendering an image. In some embodiments, the output device prints the symbol 203 onto a medium such as paper, or alternatively engraves the symbol 203 on a surface. Generally, the functionality of the output device is to simply display a symbol containing chemical structure information.

In the fourth stage of the process 200, a scanner such as a CCD scanner, a laser scanner or a CCD camera is used to read (step 203) the symbol. In another embodiment, a scanner on a personal digital assistant device is used for this purpose. The scanning device then transfers the scanned information to a processor, which is in electronic communication with the scanner. The processor interprets the scanned symbol, and decodes the symbol regenerating the originally encoding chemical structure information 201. Next, with the aid of a chemical structure drawing package or chemical structure viewer, the chemical structure information is displayed for viewing. The viewing device can include a display, or a personal digital assistant in various embodiments. The chemical structure information displayed is identical to the chemical structure information 201 provided at the start of the process 200.

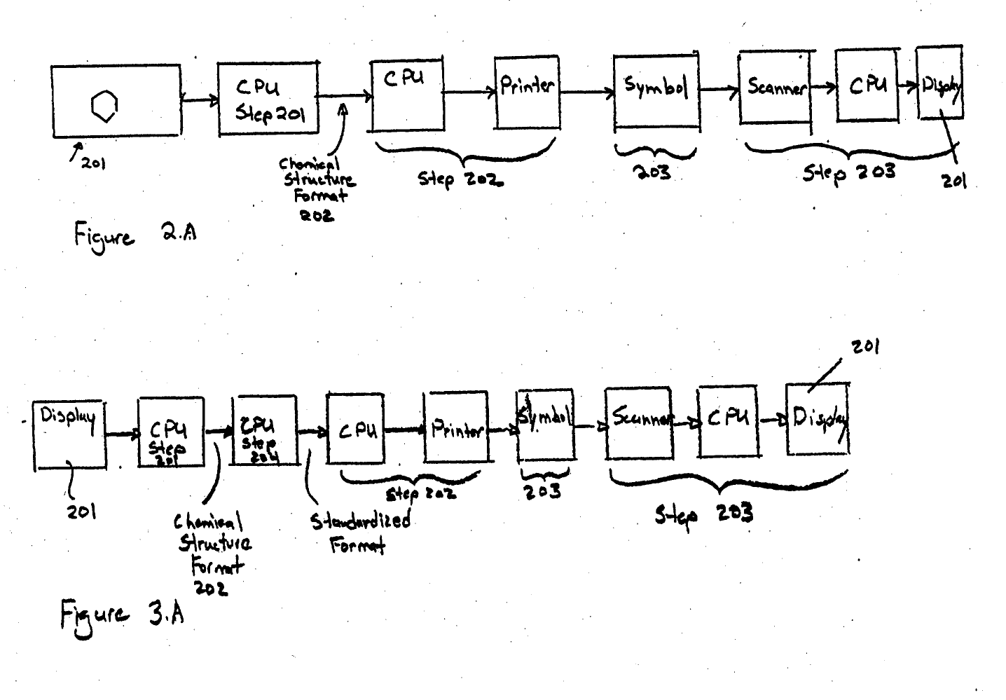

FIG. 3 and FIG. 3A depict a variation of the process described in FIG. 2 and FIG. 2A. In this embodiment, chemical structure information 201 is converted into a chemical structure format as described above. However, after the generation of the chemical structure format, a homogenizing step (step 204) is included. The homogenizing step (step 204), which is accomplished by the processor, converts the chemical structure format produced by most software packages, and converts it into a homogenized format 204. Once standardized, this data is then passed to the symbol generating component which creates a symbol 203.

One method of homogenizing chemical structure format is to import the chemical structure format from a particular software program and introduce it into a conversion program. For instance, software exists that can import and export each of the mol, .cdx, chm, .sk2, .skc, and SMILES formats. Therefore, if a particular software package is chosen to import the chemical structure format, for instance ACD/ChemSketch, then an output of a particular format can always be specified. Thus, information entering the symbol generating component can be controlled according to a known format. In other embodiments, the chemical structure information is formatted to include identifiers such that the symbol generating component recognizes the format of chemical structure data, based on the embedded identifier, independent of the data format selected. These identifiers can include simple strings or other data elements keyed to any of the possible chemical data formats available now or in the future, such as, for example, the mol, cdx, and .chm formats discussed above.

Even though a homogenized format 204 is passed to the symbol generating component, given the wide range of possible symbol formats, such as data glyphs, and 2-D barcodes, for example, multiple symbols 203 for the same molecule are possible. Thus, although once a given symbol generating component is selected, the relationship between the chemical structure and the symbols generated is one to one, the wide range of symbol generating components allows for multiple symbols to represent one chemical structure. In addition, since geometrical information related to atom position is encoded in the chemical structure format, different symbols can be generated, using the same Software package, to describe the same molecule. As another example of how multiple symbols can be generated for the same molecule, the .skp format may contain additional arbitrary information like vendor identification which will be included in the text string and hence the symbol. These symbols are distinct as result of encoding additional differing information.

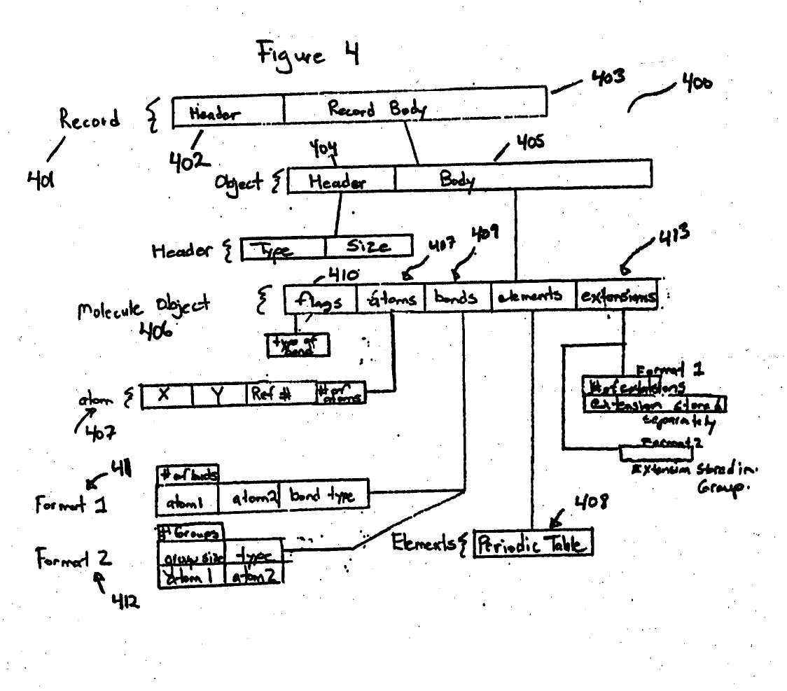

Turning to FIG. 4, a description of the .skp format (hereinafter SKP format) is provided 400. The SKP format contains a set of records 401. Each record can contain a number of objects, such as text, molecule, picture and table. A record includes a record header 402, which holds basic information about the content of the record, and the record body 403 which stores the objects themselves. Each object is also composed of two parts: a header 404 and a body 405. The structure of the object body is undefined, and depends on the exact type of the object. The object header 404 is fixed so that systems that do not support some types of objects can skip them while scanning a record. The header of an object 404 contains two fields. One field defines the type of object stored and the other holds the size of the object. The object body may be compressed by use of any of a series of known compression algorithms (e.g. LZW or Alphabet compression). If a compression program is used, then the object header should contain a corresponding flag, indicating the compression method.

One particular object in the SKP format is the molecule object 406, which consists of: flags, atoms, bonds, elements and extensions. The atoms component 407 consists of three parts. These are the X and Y coordinates of a corresponding atom, and an element reference number, which points to an item in the elements table (later described). The atoms component can have a fourth part as well for storing a Z coordinate. If a Z coordinate is included, a corresponding flag should be set in the flags field. Also included in the atoms component is a variable indicating the number of atoms in the chemical structure. The elements component 408 contains the table of elements used in the molecule. The element number is the number of the element in the periodic table. The bonds component 409 contains information on the set of bonds available in the molecule. There are two types of bond formats available, with the format being defined in the flags field 410 of the outer molecule object. In format one 411, there is a field that holds the number of bonds in the molecule. There are also fields indicating the atoms joined by a bond, and the type of bond that joins the atoms. Format two 412 groups bonds by their type. In format two 412, there is a field which indicates the number of groups in the molecule. The bonds part also contains a list of bond groups, where each group represents a pair of atoms preceded by the list length.

Lastly, extensions 413 can be used to reduce the amount of information that needs to be stored in the atoms 407 and bonds 409 components. For instance, extensions 413 can be used to hold information which is typically not present in the atoms 407 or bonds 409 components such as charge, atom labels, isotope marks, and special bond type designators. In various embodiments, extensions can be used to incorporate a repeating element in a short hand notation, thus if there are six isotopes in a given compound an extension could be used to record this one time in an abbreviated form. Extensions 413 consist of a header indicating the number of extensions, and the list of extensions themselves. Similar to bonds, extensions may be stored in two different formats. In the first format, each extension object is stored separately. In a second format, the extensions are grouped by their types. The second format may generate additional space saving when storing molecules with many extension elements of the same type.

In one embodiment (show in Table 1 below), the SKP format for H₂O is illustrated. Each cell in the third row represents one byte. Values are represented in hexadecimal form.

TABLE 1

| Header | | Atoms | | | | | Bonds | Elements | | Extensions |
|---|---|---|---|---|---|---|---|---|---|---|
| size | flags | numAtoms | Atom #1 | | | | numBonds | numElements | Data | numExt |
| 0B | 00 | 01 | 00 | 00 | 00 | 00 | 00 | 01 | 08 | 00 |

Once the SKP format of a molecule has been created by the processor, the file can be passed to the symbol generating component (step 202). The symbol generator takes the binary representation of information provided, and converts the bits into a unique symbol. The symbol can then be printed or etched into a surface as earlier described, and then later scanned to reveal the chemical structure information of the molecule without needing to utilize a database (step 203).

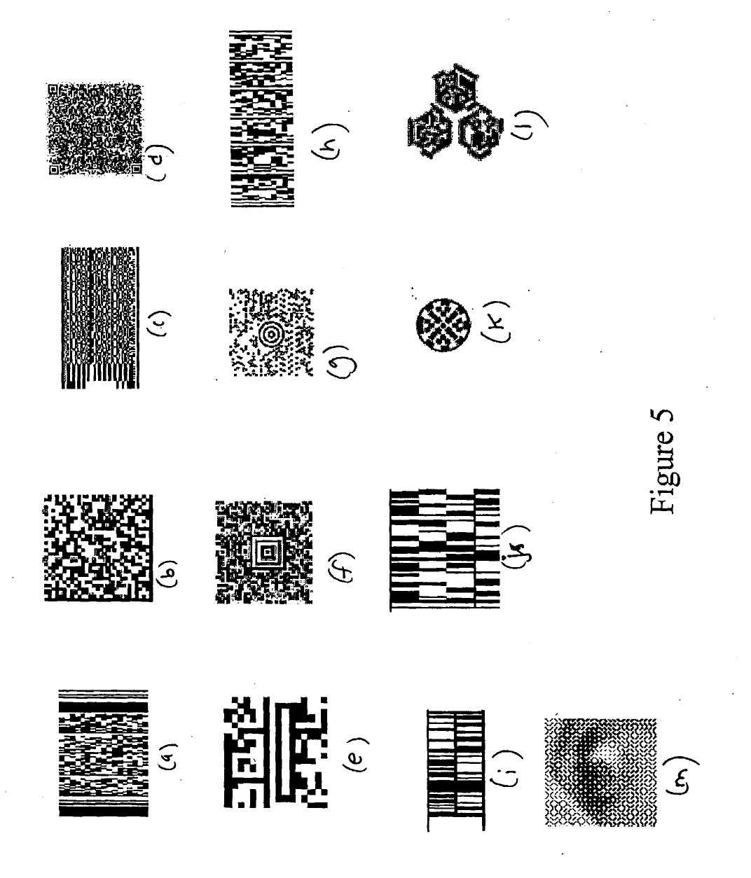

FIG. 5 depicts representative two-dimensional and three-dimensional symbols that can be used to encode chemical structure information obtained from the chemical structure format program. Ideal symbologies have a large storage capacity, are resistant to symbol damage, and include an error correction and detection system. FIGS. 5A to 5F represent 2-D symbols utilizing matrix encoding of information.

In one embodiment (FIG. 5A), the PDF417 barcode developed by Symbol Technology, which can store up to 2000 characters, is used to encode chemical structure information. PDF417 is short for Portable Data File, and is an example of a 2-D symbol that stores information in a matrix format. In a matrix format, data is coded based on the position of black spots within a matrix. Each black element is the same dimension, and it is the position of the black element that encodes the data. The PDF417 symbology consists of 17 modules, each containing 4 bars and spaces. The structure of the code allows for between 1000 to 2000 characters per symbol with an information density of between 100 and 340 characters. Moreover, the coding scheme has a high level of redundancy with the data scattered throughout the symbol. This increases the chances of the symbol being read correctly even if part of it is missing or destroyed. Using the PDF417 bar code, chemical structure information can be encoded into the symbol, and a handheld laser scanner, or a Charge Coupled Device (CCD) scanner can be used to read the symbol.

Another embodiment of a 2-D symbol is depicted in FIG. 5B called Data Matrix. Each symbol can store between 1 and 500 characters, and the symbol can also be scaled between a 1-mil square to a 14 inch square. The scalability feature allows a large amount of information to be stored in a small space. Another feature of the code is that it is not as susceptible to printing defects as traditional bar codes, since the information is encoded by absolute dot position rather than relative dot position. Moreover, the coding scheme has a high level of redundancy with the data scattered throughout the symbol. This increases the chances of the symbol being read correctly even if part of it is missing or destroyed. In the chemical and pharmaceutical industries, it is ideal to have robust labels, since chemical solvents are capable of dissolving prints. Like other 2-D symbols, Data Matrix is read by CCD video camera or CCD scanner.

In yet another embodiment, Datastrip Code as shown in FIG. 5C, can be used to encode chemical structure information. Datastrip can encode data and graphics to be printed on plain paper in a highly condensed format, and read error free into a processor using a scanner provided by Datastrip, Inc. The code consists of a matrix pattern, comprising small, rectangular black and white areas. Similar to other 2-D symbols, Datastrip also offers error correction capabilities and depending on the printing technology used to create the strip, data density can range from 150 to 1,000 bytes per square inch. Dot matrix printers, ink jets, laserjets and thermal printers can all be use to generate the symbol.

In yet another embodiment, QR Code, shown in FIG. 5D, can be used to encode chemical structure information. QR Code is a matrix code. Like other 2-D codes, QR Code can encode a large volume of information in a small space, and can be read using CCD cameras and CCD scanners.

In another embodiment of the invention, Code 1, shown in FIG. 5E can be used to encode chemical structure information. The code uses a pattern of horizontal and vertical bars crossing the middle of the symbol. The symbol can encode ASCII data, error correction data, function characters, and binary encoded data. The code comes in different sizes depending on the amount of information that needs to be stored.

As another example of a 2-D bar symbol, which can be used to encode chemical structure information, Aztec Code is shown in FIG. 5F. The symbol has a square bull's-eye finder that can be detected by a scanner. The symbol has error correction capabilities, and comes in various sizes depending on the amount of information that needs to be encoded.

In another embodiment, Maxicode, as shown in FIG. 5G can be used to encode chemical structure information. Maxicode is comprised of a 1 inch by 1 inch array of 866 interlocking hexagons, which enables approximately 100 ASCII characters to be coded into a 1 inch square symbol. There is a central bull's-eye to allow a scanner to locate the label regardless of its orientation. The symbol can be printed using a thermal or laser printer, and can be read using a CCD camera or CCD scanner.

In another aspect, SuperCode, shown in FIG. 5H can be used to encode chemical structure information. This symbol uses a packet structure, which is a variation of a multi-row symbology.

FIG. 5I and FIG. 5J represent stacked symbologies or multi-row symbols. This type of symbology is made up of a series of one-dimensional bar codes that are stacked upon each other. In this type of 2-D bar code, data is coded in a series of bars and spaces of varying width. FIG. 5I depicts code 16K. Each symbol in Code 16K contains from 2 to 16 rows, with 5 ASCII characters per row. Up to 107 16-row symbols can be concatenated together to allow encoding of up to 8,025 ASCII characters, or 16,050 numeric digits. Using the 16K Code, the maximum data density is 208 alphanumeric characters per square inch or 417 numeric digits per square inch when printed at 7.5 mils.

FIG. 5J depicts Code 49, which is more versatile than Code 16K, since it packs more information into a smaller symbol. Code 49 uses a series of bar code symbols stacked upon each other, where each symbol can have between two and eight rows. Using an x dimension of 7.5 mils, and a minimum 8 row symbol height of 0.5475 inches, the maximum theoretical density is 170 alphanumeric characters per square inch.

In addition to 2-D bar codes, 3-D bar codes can be used to encode chemical structure information. 3-D bar codes are linear bar codes that are embossed on a surface. The code is read by differences in height, rather than by differences in contrast. The code or symbol is particularly useful in the chemical industry, since it is less likely to be destroyed by chemical substances. The code is applied by either painting or coating, or can be made a permanent feature of a part. Examples of a 3-D symbol include 3-DI (FIG. 5K) and ArrayTag (FIG. 5L).

As an alternative to 2-dimensional and 3-dimensional bar codes, dataglyphs (FIG. 5M) can also be used to encode chemical structure information. Dataglyphs store information in a series of lines placed at 45 degrees relative to one another. Each line represents a “0” or a “1” in binary code. Dataglyphs can be generated by a processor, and printed onto paper, similar to the symbols described above. The symbol is read using a scanner and also incorporates an error detection and correction system.

Although a selection of various codes and symbols have been discussed, the invention is suitable for use with any symbol generating device or process existing now or as of yet undeveloped which is capable of converting a data string into a symbol.

While the present invention has been described in terms of certain exemplary preferred embodiments, it will be readily understood and appreciated by one of ordinary skill in the art that it is not so limited and that many additions, deletions, and modifications to the preferred embodiments may be made within the scope of the invention as hereinafter claimed. Accordingly, the scope of the invention is limited only by the scope of the appended claims.

What is claimed is:

1. A method of encoding chemical information, the method comprising the steps of:
providing chemical structure information; and
generating a symbol having a specific configuration in response to the chemical structure information, wherein the chemical structure information is derivable from the specific configuration of the symbol.

2. The method of claim 1 wherein the symbol is a two-dimensional barcode.

3. The method of claim 1 wherein the step of generating the symbol comprises processing a binary representation of the chemical structure information.

4. The method of claim 1 wherein the chemical structure information is represented according to the Simplified Molecular Input Line Entry System.

5. The method of claim 1 further comprising the step of scanning the symbol to obtain the chemical structure information.

6. The method of claim 1 wherein the chemical structure information comprises at least atomic position information and atomic connectivity information.

7. The method of claim 1 further comprising the step of generating a character string from the chemical structure information.

8. The method of claim 7 wherein prior to the step of generating the symbol, the method includes the step of generating homogenized chemical structure data from the character string.

9. The method of claim 1 wherein the symbol is in a PDF417 format.

10. The method of claim 1 wherein the chemical structure information comprises a character string representative of a chemical structure.

11. A method of encoding a chemical structure, the method comprising the steps of:
providing chemical structure information;
generating a character string from the chemical structure information;
converting the character string into homogenized chemical structure data; and
generating a symbol in response to the homogenized chemical structure data, wherein the symbol is functionally related to the chemical structure information.

12. The method of claim 11 wherein the symbol is a two-dimensional barcode.

13. The method of claim 11 wherein the step of generating the symbol comprises processing a binary representation of the chemical structure information.

14. The method of claim 11 wherein the chemical structure information is represented according to the Simplified Molecular Input Line Entry System.

15. The method of claim 11 further comprising the step of scanning the symbol to obtain the chemical structure information.

16. The method of claim 11 wherein the chemical structure information comprises at least atomic position information and atomic connectivity information.

17. The method of claim 11 wherein the homogenized chemical structure data is in a general database binary format.

18. The method of claim 11 wherein the symbol is formatted according to the PDF417 barcode format.

19. The method of claim 11 wherein the chemical structure information comprises a character string representative of a chemical structure.

20. An apparatus for processing chemical structure information, the apparatus comprising:
a processor for receiving and processing chemical structure information, the processor generating a symbol functionally related to the chemical structure information in response to the chemical structure information; and
an output device for displaying the symbol, wherein the output device is in electronic communication with the processor.

21. The apparatus of claim 20 wherein the processor is an element in a computer.

22. The apparatus of claim 20 wherein the processor is an element in a personal digital assistant.

23. The apparatus of claim 20 wherein the output device is a printer.

24. The apparatus of claim 20 wherein the output device is a display.

25. An apparatus for processing a symbol encoding chemical structure information, the apparatus comprising:
a processor for receiving and processing symbol scan information, the processor generating chemical structure information in response to symbol scan information, wherein the chemical structure information is functionally related to the symbol; and
a scanning device for scanning the symbol and transmitting the symbol scan information to the processor, wherein the scanning device is in electronic communication with the processor.

26. The apparatus of claim 25 wherein the scanning device is a handheld laser scanner.

27. The apparatus of claim 25 wherein the scanning device is a handheld CCD scanner.

28. A system for encoding and decoding chemical structure information, the system comprising:
a processor for encoding chemical information as a symbol and decoding the chemical information contained within the symbol, wherein the chemical structure information and the symbol are derivable from each other;
a symbol scanner for transmitting symbol scan information to the processor, wherein the scanner is in electronic communication with the processor and the symbol scan information is convertible to chemical structure information by the processor; and
an output device for displaying the symbol created in response to the chemical structure information, wherein the output device is in electronic communication with the processor.

29. A symbol for encoding chemical structure information, the symbol comprising:
a first plurality of geometric regions disposed within a defined area;
a second plurality of geometric regions chromatically distinct from the first plurality of regions and disposed within the defined area, wherein the first and second regions are arranged in a pattern such that arrangement of the chromatically distinct regions encodes a chemical structure of interest.

30. A method of encoding chemical structure information, the method comprising the steps of:
providing a first plurality of geometric regions disposed within a defined area; and
providing a second plurality of geometric regions chromatically distinct from the first plurality of regions and disposed within the defined area, wherein the first and second chromatically distinct regions encode a chemical structure of interest.
